(19) United States
(12) Patent Application Publication
(10) Pub. No.: US 2023/0410170 A1
(43) Pub. Date: Dec. 21, 2023

(54) OPTIMIZED MANAGEMENT OF TRANSACTION REQUESTS

(71) Applicant: Capital One Services, LLC, McLean, VA (US)

(72) Inventors: Bharath CHEKURI, Plano, TX (US); Isha MEHTA, Sugar Land, TX (US); Esmeralda CERVANTES, The Colony, TX (US); Swati SARAF, Frisco, TX (US); Poojitha PONUGOTI, Allen, TX (US)

(73) Assignee: Capital One Services, LLC, McLean, VA (US)

(21) Appl. No.: 17/840,872

(22) Filed: Jun. 15, 2022

(51) Int. Cl. G06Q 20/38; G06Q 30/06

(52) U.S. Cl. CPC G06Q 20/38; G06Q 30/0641

(57) ABSTRACT

A computing device (e.g., a server, a cloud-based device, a request management device, etc.), for example, such as a computing device associated with a vehicle dealership and/or the like, may receive a plurality of transaction requests, such as requests to purchase, lease, and/or finance a vehicle. Each transaction request may include user information associated with the transaction, such as a phone number, a home/mailing address, email address, a credit score, vehicle trade-in information, and/or any other data elements. For each transaction request, the computing device may invoke one or more microservices to verify data elements of user information and use responses from the microservices to rank each transaction requests on its potential to progress to a completed transaction.

### BACKGROUND

A merchant device (e.g., a computing device, a point-of-sale device, a dealer/agent device, a mobile device, a smart device, etc.), for example, a device operated by a vehicle dealership and/or the like, receives leads (e.g., indications of potential consumers, transaction requests, etc.) from various sources and/or containing various forms of information (e.g., phone numbers, home/mailing addresses, email addresses, credit scores, vehicle trade-in information, etc.) describing one or more aspects of potential consumers (e.g., individuals that have expressed an interest in purchasing, leasing, or financing a vehicle, etc.). Conventionally, a significant portion of leads received by the merchant device lacks some form of necessary information and/or includes incorrect/invalid information. Leads that lack some form of necessary information and/or include incorrect/invalid information rarely progress to completed transactions, for example, such as vehicle sales and/or the like. Merchant devices and/or users operating the merchant devices, such as a vehicle salesperson and/or the like, are unable to filter out leads that lack some form of necessary information and/or include incorrect/invalid information from leads with complete and/or accurate information, such as leads that will likely lead to a completed transaction (e.g., vehicle sale, etc.). Merchant devices and/or users operating the merchant devices are unable to receive automated notifications of leads with complete and/or accurate information, such as leads that will likely lead to a completed transaction.

### BRIEF DESCRIPTION OF THE FIGURES

The accompanying drawings, which are incorporated herein and form part of the specification, illustrate the present disclosure and, together with the description, further serve to explain the principles of the disclosure and enable a person skilled in the relevant art to make and use the disclosure.

FIG. 1 is a block diagram of an example system for optimized management of transaction requests, according to some aspects.

FIG. 2 shows an example system for training a lead evaluation module, according to some aspects.

FIG. 3 shows a flowchart of an example training method for generating a machine learning classifier to classify transaction requests, according to some aspects.

FIG. 4 illustrates an example method for optimized management of transaction requests, according to some aspects.

FIG. 5 is an example computer system useful for implementing various aspects disclosed herein.

In the drawings, like reference numbers generally indicate identical or similar elements. Additionally, generally, the left-most digit(s) of a reference number identifies the drawing in which the reference number first appears.

### DETAILED DESCRIPTION OF THE INVENTION

Merchants operating merchant devices (e.g., computing devices, point-of-sale devices, a dealer/agent device, a mobile device, a smart device, etc.), for example, a device operated by a vehicle dealership and/or the like, vehicle dealership, and/or the like, need a filtering mechanism to distinguish leads that lack some form of necessary information (e.g., phone numbers, home/mailing addresses, email addresses, credit scores, vehicle trade-in information, etc.) and/or include incorrect/invalid information from leads with complete and/or accurate information, such as leads that will likely lead to a completed transaction (e.g., vehicle sale, etc.). Conventionally, determining leads that will likely lead to a completed transaction is a manual and/or a restrictively laborious task. For example, to determine leads that will likely lead to a completed transaction (e.g., vehicle sale, etc.), merchant devices and/or users operating the merchant devices must review hundreds of leads on a daily basis and make effort to determine and/or validate necessary information, incorrect information, and/or invalid information.

Described herein are methods and systems for optimized management of transaction requests. According to some aspects, a computing device (e.g., a server, a cloud-based device, a request management device, etc.), for example, such as a computing device associated with a vehicle dealership and/or the like, may receive a plurality of transaction requests. For example, the computing device may host and/or facilitate a merchant webpage, application, interface, and/or the like that enables potential customers to submit transaction requests. According to some aspects, a transaction request may include, for example, a request to purchase, lease, and/or finance a vehicle. According to some aspects, a transaction request may include an exploratory request, for example, such as a request to test drive and/or preview a vehicle, a request for a price and/or availability quote for a vehicle (and/or any other product, item, content, etc.), a request for data analysis (e.g., buyer prequalification, credit evaluation, etc.), and/or the like. According to some aspects, a transaction request may include, but is not limited to, a communication of any information associated with a user, potential customer, customer, and/or the like indicating potential and/or intent for an interaction.

According to some aspects, each transaction request may include user information associated with the transaction, such as a phone number, a home/mailing address, an email address, a credit score, vehicle trade-in information, and/or any other data elements. For each transaction request, one or more microservices may be tasked to verify data elements of user information. A rank for each transaction request may be determined, for example, based on a number of responses from components of the one or more microservices indicating that data elements of user information are verified. The ranked transaction requests, for example, a highest ranked transaction request and/or the like, may be sent to a merchant device. The merchant device and/or a user operating the merchant device, such as a vehicle salesperson and/or the like, may communicate with and/or otherwise engage users associated with the ranked transaction requests to facilitate a completed transaction (e.g., a vehicle sale, etc.) without expending computational resources, network/system bandwidth, and/or personnel resources pursuing transaction requests that lack some form of necessary information and/or include incorrect/invalid information. These and other technological advantages are described herein.

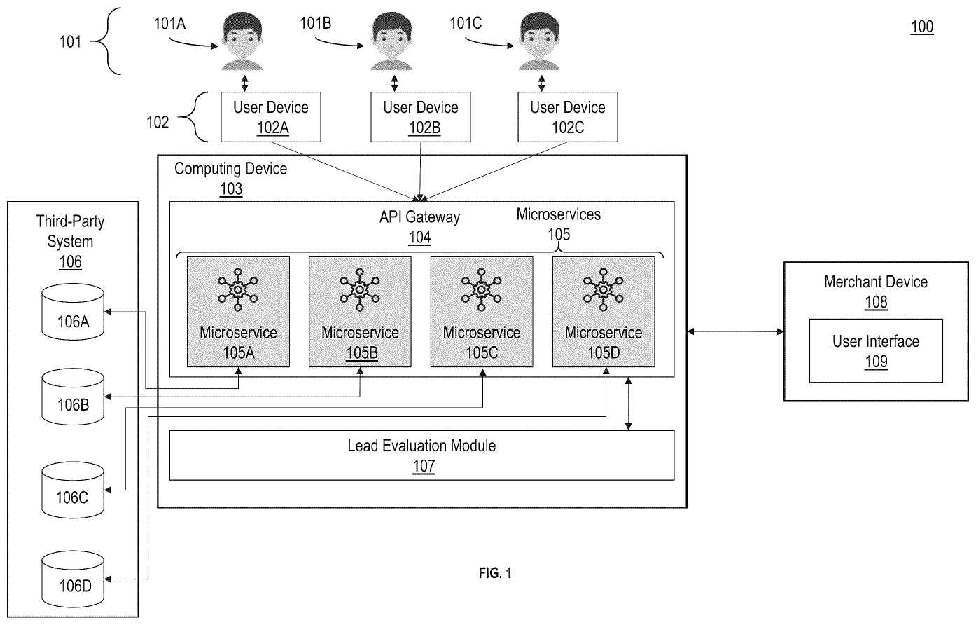

FIG. 1 is a block diagram of an example system 100 for optimized management of transaction requests, according to some aspects. The system 100 may include user devices 102, a computing device 103, third-party systems 106, and a merchant device 108.

According to some aspects, a user device 102 may include a mobile device, a computing device, a smart device, and/or the like. The system may include any number of user devices 102, for example, such as user devices 102A-102C. Each user device may be associated with a user 101. For example, the user devices 102A-102C may each be associated with respective users 101A-101C. According to some aspects, a user 101 may be a lead, such as a potential consumer of a merchant. For example, the users 101A-101C may each be potential consumers of a vehicle dealership and/or the like, such as individuals desiring or potentially desiring to purchase, lease, and/or finance a vehicle, etc.

According to some aspects, each user device 102 may include and/or be in communication with a user interface (not shown), such as an application, a web-based interface (e.g., a web browser, etc.), a customer portal, and/or the like that enables the user device 102 and/or the user 101 to communicate with any device and/or component of the system 100, such as the computing device 103. For example, each user device 102 may include and/or be in communication with a user interface that enables the user 101 to submit transaction requests to the computing device 103. For example, a user 101 may use a user device 102 to access a merchant webpage, application, customer portal, and/or the like to submit transaction requests, such as requests and/or inquiries associated with or indicative of a potential to finance, lease, and/or purchase a vehicle.

According to some aspects, the computing device 103 (e.g., a server, a cloud-based device, a request management device, etc.) may receive transaction requests from the user devices 102. For example, a transaction request may include a request to purchase, lease, and/or finance a vehicle. According to some aspects, a transaction request may include an exploratory request, for example, such as a request to test drive and/or preview a vehicle, a request for a price and/or availability quote for a vehicle (and/or any other product, item, content, etc.), a request for data analysis (e.g., buyer prequalification, credit evaluation, etc.), and/or the like. According to some aspects, a transaction request may include, but is not limited to, a communication of any information associated with a user, potential customer, customer, and/or the like indicating potential and/or intent for an interaction.

According to some aspects, the computing device 103 may host and/or facilitate a merchant webpage, application, interface, and/or the like that enables a user device 102 to submit transaction requests. For example, the computing device 103 may include and/or be in communication with an Application Programming Interface (API) gateway 104. According to some aspects, the API gateway 104 may receive transaction requests, for example, transaction requests and/or data indicative of the transaction requests may be submitted to the API gateway 104 as API calls and/or the like.

According to some aspects, the API gateway may be in communication with microservices 105. According to some aspects, API calls and/or the like that are indicative of transaction requests and/or data elements of transaction requests may be used to determine a microservice of the microservices 105, such as the microservices 105A-105D. The system 100 may include and/or support any number of microservices. The computing device 103 may parse and/or analyze each transaction request to determine user information that may be used to determine microservices of the microservices 105. For example, each transaction request may include user information associated with the transaction, such as a phone number, a home/mailing address, an email address, a credit score, vehicle trade-in information, and/or any other data elements.

According to some aspects, the computing device 103, for example, via the API gateway 104, may determine microservices 105, such as the microservices 105A-105D, that correspond to data elements of a transaction request. The computing device 103, for example, via the API gateway 104, may send a request ad/or command to a microservice component (e.g., application function, logic application, code executor, etc.) of any microservice of the microservices 105, for the microservice to implement and/or facilitate verification and/or validation of a data element received with a transaction request.

For each transaction request, one or more of the microservices 105 may be tasked to verify data elements of user information. For example, the microservice 105A may be tasked to verify phone numbers received with transaction requests to ensure that the phone numbers are valid phone numbers and/or are associated with a particular user 101. The microservice 105B may be tasked to verify email addresses received with transaction requests to ensure that the email addresses are valid and/or are associated with a particular user 101. The microservice 105C may be tasked to verify mailing addresses received with transaction requests to ensure that the mailing addresses are valid and/or are associated with a particular user 101. The microservice 105D may be tasked to verify information such as purchase histories, credit scores, and/or trade-in values for assets (e.g., vehicles, collaterals, etc.) received with transaction requests to ensure that a particular user is qualified to complete a transaction and/or the like. The microservices 105 may include any type of microservice tasked to verify, validate, and/or ensure any type of data element and/or the like received with a transaction request.

According to some aspects, to verify, validate, and/or ensure any type of data element and/or the like received with a transaction request, the microservices 105 may communicate with third-party systems 106. According to some aspects, each system of the third-party systems 106 may include one or more devices, data repositories, applications, networks, that operate collectively to facilitate verification and/or validation of data elements. For example, the microservice 105A may communicate with a third-party system 106A, such as a Public Switched Telephone Network (PSTN), a phone verification API/tool, a reverse phone lookup system, and/or the like to verify phone numbers received with transaction requests to ensure that the phone numbers are valid phone numbers and/or are associated with a particular user 101. The microservice 105B may communicate with a third-party system 106B, such as a real-time verification API, a bulk email list verification system, an email ping device, a public records system, and/or the like to verify email addresses received with transaction requests to ensure that the email addresses are valid and/or are associated with a particular user 101. The microservice 105C may communicate with a third-party system 106C, such as an address verification service (AVS), public records, and/or the like to verify mailing addresses received with transaction requests to ensure that the mailing addresses are valid and/or are associated with a particular user 101. The microservice 105D may communicate with a third-party system 106D, such as credit bureaus, associated merchants, blockchain and/or digital ledger systems storing validated user information, public/private records systems, and/or the like to verify information such as purchase histories, credit scores, and/or trade-in values for assets (e.g., vehicles, collaterals, etc.) received with transaction requests to ensure that a particular user is qualified to complete a transaction and/or the like. The third-party systems 106 may include any type of system, device, application, and/or the like that verify and/or validate data elements of user information received with transaction requests.

According to some aspects, the computing device 103 may determine a rank for each transaction request. For example, the computing device 103 may include a lead evaluation module 107. The lead evaluation module 107 may evaluate and/or rank each transaction request received from a user device 102 as a lead. Lead (e.g., indications that the users 101 will complete a transaction, etc.) evaluations and/or rankings may be based on one or more aspects of information received from the microservices 105, for example, such as a number of responses from microservices components of the microservices 105 indicating that data elements of user information are verified. The lead evaluation module 107 may evaluate each transaction request, for example, to determine and/or rank the potential for the transaction request to progress to a completed transaction, according to any aspects of information received from the microservices 105.

According to some aspects, the lead evaluation module 107 may include a machine learning model trained to evaluate transaction requests. The machine learning model may evaluate and/or rank transaction requests according to any criteria, conditions, and/or situational factors. For example, according to some aspects, the machine learning model may determine and/or rank the potential for the transaction request to progress to a completed transaction. According to some aspects, an evaluation and/or rank of a transaction request may consider conditions and/or situational factors including, but not limited to, a device, a source, a medium (e.g., a webpage, an online interactive element, telephone, direct contact, etc.), and/or communication channel through which the transaction request is received, and/or the like. For example, a transaction request received via a webpage and/or online resource may be evaluated and/or ranked differently than a transaction request received via direct contact (e.g., a telephone call, visitation by a user to a business location/site, etc.) to a business entity.

According to some aspects, an evaluation and/or rank of a transaction request may consider conditions and/or situational factors including, but not limited to, an amount of time a digital property associated with transaction requests is accessed, visited, searched, and/or the like. For example, a first transaction request that includes information indicative of the amount of time a digital property associated with transaction requests is accessed, visited, searched, and/or the like that is greater than a second transaction request may be ranked higher than the second transaction request.

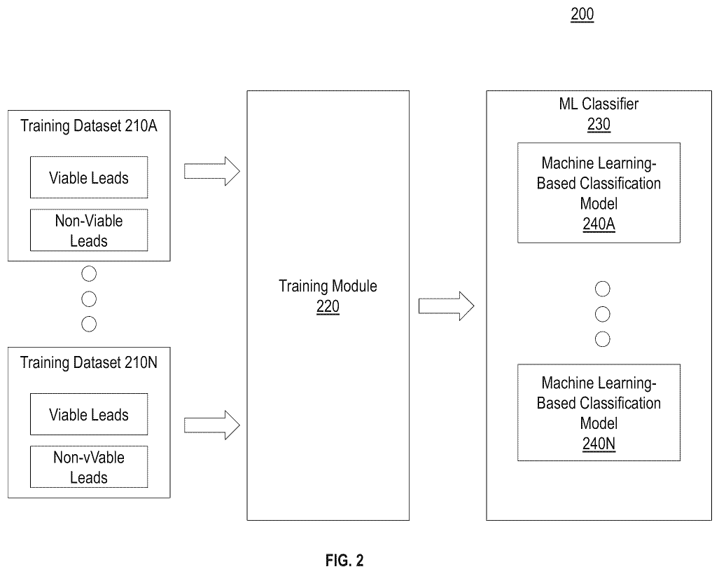

FIG. 2 is an example system 200 for training the lead evaluation module 107 to evaluate and/or rank transaction requests received from the user devices 102, according to some embodiments. FIG. 2 is described with reference to FIG. 1. The system 200 may use machine learning techniques to train, based on an analysis of one or more training datasets 210A-210N by the lead evaluation module 107 of FIG. 1, at least one machine learning-based classifier 230 (e.g., a software model, neural network classification layer, etc.). The classifier 230 may be configured to classify features extracted from data/information processed by one or more microservices (e.g., the microservices 105, etc.), for example, such as phone numbers, home/mailing addresses, email addresses, credit scores, vehicle trade-in information, situational factors, and/or indications from one or more microservices that such user information has been verified, validated, and/or the like. The machine learning-based classifier 230 may classify features extracted from data/information processed by the microservices 105 to rank transaction requests according to a lead quality metric that may be used to indicate transaction requests that are most likely to progress to completed transactions. According to some aspects, the lead quality metric may also be based on any other criteria, conditions, and/or situational factors as described herein.

The one or more training datasets 210A-210N may comprise labeled baseline data such as labeled combinations of data elements that, based on whether one or more verified/validated data elements of the combined data elements suggest that a transaction request is from a quality lead (e.g., a user 101 likely to complete a transaction, etc.). For example, according to some aspects, labeled baseline data may indicate one or more response thresholds for transaction requests that may be used to evaluate the number of responses from microservice components of the microservices 105 that indicate that data elements included with the transaction requests are verified and/or validated. According to some aspects, response thresholds may be used to evaluate whether a transaction request is to be deemed a quality lead. According to some aspects, labeled baseline data may indicate that a transaction request with data elements such as a phone number and credit score/history that have been verified and/or validated is to be considered a quality lead even if other data elements such as an email address or an asset trade-in value have not been verified and/or validated. Labeled baseline data may be labeled to indicate any desired scenario and/or data combination for assessing the quality of leads based on transaction requests and/or microservice processing of transaction requests.

The labeled baseline data may be stored in one or more databases. Data (e.g., microservices 105 communications, responses from third-party systems 106, etc.) for optimizing and/or ranking transaction requests may be randomly assigned to a training dataset or a testing dataset. According to some aspects, the assignment of data to a training dataset or a testing dataset may not be completely random. According to some aspects, one or more criteria may be used during the assignment, such as ensuring that similar indicators of quality leads, dissimilar indicators of quality leads, and/or the like may be used in each of the training and testing datasets. In general, any suitable method may be used to assign the data to the training or testing datasets.

The lead evaluation module 107 may train the machine learning-based classifier 230 by extracting a feature set from the labeled baseline data according to one or more feature selection techniques. According to some aspects, the lead evaluation module 107 may further define the feature set obtained from the labeled baseline data by applying one or more feature selection techniques to the labeled baseline data in the one or more training datasets 210A-210N. The lead evaluation module 107 may extract a feature set from the training datasets 210A-210N in a variety of ways. The lead evaluation module 107 may perform feature extraction multiple times, each time using a different feature-extraction technique. In some instances, the feature sets generated using the different techniques may each be used to generate different machine learning-based classification models 240. According to some aspects, the feature set with the highest quality metrics may be selected for use in training. The lead evaluation module 107 may use the feature set(s) to build one or more machine learning-based classification models 240A-240N that are configured to rank transaction requests from user devices 102, for example, based on a potential to progress to a completed transaction, and/or any other criteria, conditions, and/or situational factors.

According to some aspects, the training datasets 210A-210N and/or the labeled baseline data may be analyzed to determine any dependencies, associations, and/or correlations between validated/verified data element types and/or the like in the training datasets 210A-210N and/or the labeled baseline data. The term “feature,” as used herein, may refer to any characteristic of an item of data that may be used to determine whether the item of data falls within one or more specific categories. For example, the features described herein may comprise any data element, any combination of data elements (e.g., validated/verified data elements vs data elements that have not been validated/verified, etc.)

According to some aspects, a feature selection technique may comprise one or more feature selection rules. The one or more feature selection rules may comprise determining which features in the labeled baseline data appear over a threshold number of times in the labeled baseline data and identifying those features that satisfy the threshold as candidate features. For example, any features that appear greater than or equal to 2 times in the labeled baseline data may be considered candidate features. Any features appearing less than 2 times may be excluded from consideration as a feature. According to some aspects, a single feature selection rule may be applied to select features or multiple feature selection rules may be applied to select features. According to some aspects, the feature selection rules may be applied in a cascading fashion, with the feature selection rules being applied in a specific order and applied to the results of the previous rule. For example, the feature selection rule may be applied to the labeled baseline data to generate information (e.g., scenarios and/or combinations of verified/validated data elements that indicate whether a user 101 will complete a transaction, etc.) that may be used to optimize management of transaction requests. A final list of candidate features may be analyzed according to additional features.

According to some aspects, the lead evaluation module 107 may generate information (e.g., an indication of verified/validated data element combinations, etc.) that may be used to optimize management of transaction requests may be based on a wrapper method. A wrapper method may be configured to use a subset of features and train the machine learning model using the subset of features. Based on the inferences that are drawn from a previous model, features may be added and/or deleted from the subset. Wrapper methods include, for example, forward feature selection, backward feature elimination, recursive feature elimination, combinations thereof, and the like. According to some aspects, forward feature selection may be used to identify one or more candidate leads and/or the like. Forward feature selection is an iterative method that begins with no feature in the machine learning model. In each iteration, the feature which best improves the model is added until the addition of a new variable does not improve the performance of the machine learning model. According to some aspects, backward elimination may be used to identify one or more candidate leads and/or the like. Backward elimination is an iterative method that begins with all features in the machine learning model. In each iteration, the least significant feature is removed until no improvement is observed on the removal of features. According to some aspects, recursive feature elimination may be used to identify one or more candidate leads and/or the like. Recursive feature elimination is a greedy optimization algorithm that aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

According to some aspects, one or more candidate leads and/or the like may be determined according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to an absolute value of the magnitude of coefficients and ridge regression performs L2 regularization which adds a penalty equivalent to the square of the magnitude of coefficients.

After lead evaluation module 107 generates a feature set(s), the lead evaluation module 107 may generate a machine learning-based predictive model 240 based on the feature set(s). Machine learning-based predictive model may refer to a complex mathematical model for data classification that is generated using machine-learning techniques. For example, this machine learning-based classifier may include a map of support vectors that represent boundary features. By way of example, boundary features may be selected from, and/or represent the highest-ranked features in, a feature set.

According to some aspects, the lead evaluation module 107 may use the feature sets extracted from the training datasets 210A-210N and/or the labeled baseline data to build a machine learning-based classification model 240A-240N to determine and/or rank leads. According to some aspects, the machine learning-based classification models 240A-240N may be combined into a single machine learning-based classification model 240. Similarly, the machine learning-based classifier 230 may represent a single classifier containing a single or a plurality of machine learning-based classification models 240 and/or multiple classifiers containing a single or a plurality of machine learning-based classification models 240. According to some aspects, the machine learning-based classifier 230 may also include each of the training datasets 210A-210N and/or each feature set extracted from the training datasets 210A-210N and/or extracted from the labeled baseline data. Although shown separately, lead evaluation module 107 may include the machine learning-based classifier 230.

The extracted features from data/information processed by one or more microservices (e.g., the microservices 105, etc.), for example, such as phone numbers, home/mailing addresses, email addresses, credit scores, vehicle trade-in information, and/or indications from one or more microservices that such user information has been verified, validated, and/or the like may be combined in a classification model trained using a machine learning approach such as discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting machine learning-based classifier 230 may comprise a decision rule or a mapping that uses data/information processed by one or more microservices (e.g., the microservices 105, etc.), for example, such as phone numbers, home/mailing addresses, email addresses, credit scores, vehicle trade-in information, and/or indications from one or more microservices that such user information has been verified, validated, and/or the like to determine and/or rank transaction request as leads and/or the like.

The data/information processed by one or more microservices (e.g., the microservices 105, etc.) and the machine learning-based classifier 230 may be used to determine a quality metric (e.g., a high-ranking lead, a low-ranking lead, etc.) for a transaction request for the test samples in the test dataset. For example, the result for each test sample may include a confidence level that corresponds to a likelihood or a probability that the corresponding test sample accurately determines and/or ranks transactions requests (e.g., leads, etc.) based on the potential to progress to a completed transaction, and/or any other criteria, conditions, and/or situational factors. The confidence level may be a value between zero and one that represents a likelihood that the determined/ranked transaction requests and/or the like is consistent with a computed value. Multiple confidence levels may be provided for each test sample and each candidate (approximated) candidate lead and/or the like. A top-performing candidate lead and/or the like may be determined by comparing the result obtained for each test sample with a computed lead and/or the like for each test sample. In general, the top-performing candidate lead and/or the like will have results that closely match the computed lead and/or the like. The top-performing candidate lead and/or the like may be used for optimizing the management of transaction requests.

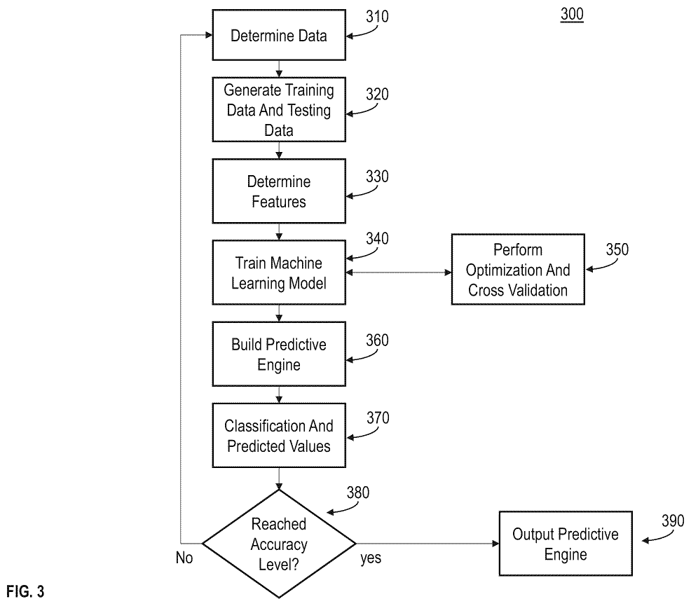

FIG. 3 is a flowchart illustrating an example training method 300 for generating the machine learning classifier 230 using the lead evaluation module 107, according to some aspects. The lead evaluation module 107 can implement supervised, unsupervised, and/or semi-supervised (e.g., reinforcement-based) machine learning-based classification models 240. The method 300 shown in FIG. 3 is an example of a supervised learning method; variations of this example of training method are discussed below, however, other training methods can be analogously implemented to train unsupervised and/or semi-supervised machine learning (predictive) models. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIGS. 1 and 2. However, method 300 is not limited to the aspects of those figures.

In 310, the lead evaluation module 107 determines (e.g., access, receive, retrieve, etc.) data/information processed by one or more microservices (e.g., the microservices 105, etc.), for example, such as phone numbers, home/mailing addresses, email addresses, credit scores, vehicle trade-in information, and/or indications from one or more microservices that such user information has been verified, validated, and/or the like. The data/information may contain one or more datasets, each dataset associated with a transaction request from each of the user devices 102.

In 320, the lead evaluation module 107 generates a training dataset and a testing dataset. According to some aspects, the training dataset and the testing dataset may be generated by indicating scenarios and/or combinations of verified/validated data elements that indicate whether a user, such as the users 101 and/or the like, will complete a transaction. According to some aspects, the training dataset and the testing dataset may be generated by randomly assigning a scenario and/or a combination of verified/validated data elements that indicate whether a user will complete a transaction to either the training dataset or the testing dataset. According to some aspects, only the labeled baseline data for a specific feature extracted from specific data/information processed by one or more microservices (e.g., the microservices 105, etc.), such as data elements that have been verified, validated, and/or the like may be used to generate the training dataset and the testing dataset. According to some aspects, a majority of the labeled baseline data extracted from data/information processed by one or more microservices may be used to generate the training dataset. For example, 75% of the labeled baseline data for determining a quality metric for a transaction request, lead, and/or the like may be used to generate the training dataset and 25% may be used to generate the testing dataset. Any method or technique may be used to create the training and testing datasets.

In 330, the lead evaluation module 107 determines (e.g., extract, select, etc.) one or more features that can be used by, for example, a classifier (e.g., a software model, a classification layer of a neural network, etc.) to label features extracted from a variety of data/information processed by one or more microservices (e.g., the microservices 105, etc.). One or more features may comprise indications of scenarios and/or combinations of verified/validated data elements that indicate whether a user will complete a transaction. According to some aspects, the lead evaluation module 107 may determine a set of training baseline features from the training dataset. Features of data/information processed by one or more microservices (e.g., the microservices 105, etc.) may be determined by any method.

In 340, the lead evaluation module 107 trains one or more machine learning models, for example, using one or more features. According to some aspects, the machine learning models may be trained using supervised learning. According to some aspects, other machine learning techniques may be employed, including unsupervised learning and semi-supervised. The machine learning models trained in 340 may be selected based on different criteria (e.g., how close a transaction request predicted to be a quality and/or high-ranking lead is to an actual transaction request that progressed to a completed transaction, etc.) and/or data available in the training dataset. For example, machine learning classifiers can suffer from different degrees of bias. According to some aspects, more than one machine learning model can be trained.

In 350, the lead evaluation module 107 optimizes, improves, and/or cross-validates trained machine learning models. For example, data for training datasets and/or testing datasets may be updated and/or revised to include more labeled data indicating different scenarios and/or combinations of verified/validated data elements that indicate whether a user will complete a transaction.

In 360, the lead evaluation module 107 selects one or more machine learning models to build a predictive model (e.g., a machine learning classifier, a predictive engine, etc.). The predictive model may be evaluated using the testing dataset.

In 370, the lead evaluation module 107 executes the predictive model to analyze the testing dataset and generate classification values and/or predicted values.

In 380, the lead evaluation module 107 evaluates classification values and/or predicted values output by the predictive model to determine whether such values have achieved the desired accuracy level. Performance of the predictive model may be evaluated in a number of ways based on a number of true positives, false positives, true negatives, and/or false negatives classifications of the plurality of data points indicated by the predictive model. For example, the false positives of the predictive model may refer to the number of times the predictive model incorrectly predicted and/or determined a transaction request to be a quality and/or high-ranking lead that did not progress to a completed transaction (and/or the like). Conversely, the false negatives of the predictive model may refer to the number of times the machine learning model predicted and/or determined a transaction request not to be a quality and/or high-ranking lead, when in fact, the transaction request progressed to a complete transaction (and/or the like). True negatives and true positives may refer to the number of times the predictive model correctly predicted and/or determined a quality metric and/or ranking for a transaction request. Related to these measurements are the concepts of recall and precision. Generally, recall refers to a ratio of true positives to a sum of true positives and false negatives, which quantifies the sensitivity of the predictive model. Similarly, precision refers to a ratio of true positives as a sum of true and false positives.

In 390, the lead evaluation module 107 outputs the predictive model (and/or an output of the predictive model). For example, lead evaluation module 107 may output the predictive model when such a desired accuracy level is reached. An output of the predictive model may end the training phase.

According to some aspects, when the desired accuracy level is not reached, in 390, lead evaluation module 107 may perform a subsequent iteration of the training method 300 starting at 310 with variations such as, for example, considering a larger collection of data/information processed by one or more microservices (e.g., the microservices 105, etc.), such as phone numbers, home/mailing addresses, email addresses, credit scores, vehicle trade-in information, and/or indications from one or more microservices that such user information has been verified, validated, and/or the like.

Returning to FIG. 1, transaction requests evaluated and/or ranked by the lead evaluation module 107, for example, a highest-ranked transaction request and/or the like, may be sent to the merchant device 108 (e.g., a computing device, a point-of-sale device, a dealer/agent device, a mobile device, a smart device, etc.). According to some aspects, information associated with the evaluated and/or ranked transaction requests, such as verified/validated data elements and/or the like, may be sent to the merchant device 108. The merchant device may include a user interface 109 (e.g., an application, a web-based interface, a merchant/dealer portal, and/or the like) configured to display transaction requests (and/or information associated with transaction requests) evaluated and/or ranked by the lead evaluation module 107. For example, the merchant device 108 may display a list of transaction requests (e.g., leads, etc.) that satisfy a ranking threshold.

According to some aspects, the merchant device 108 and/or a user operating the merchant device, such as a vehicle salesperson and/or the like, may communicate with and/or otherwise engage users (e.g., the users 101, etc.) associated with the ranked transaction requests to facilitate a completed transaction (e.g., a vehicle sale, etc.) without expending computational resources, network/system bandwidth, and/or personnel resources pursuing transaction request that lack some form of necessary information and/or include incorrect/invalid information.

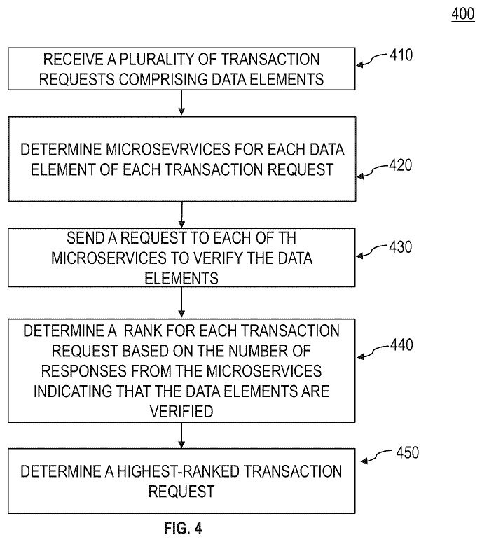

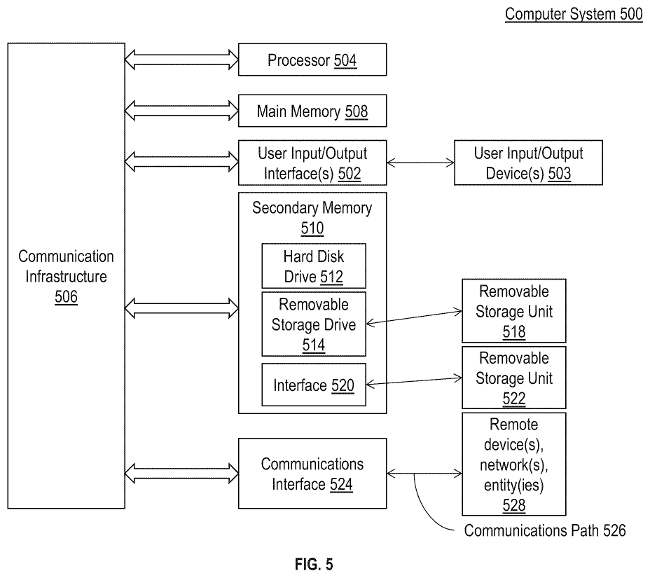

FIG. 4 illustrates an example computer-implemented method 300 for optimized management of transaction requests, according to some aspects of this disclosure. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps can be performed simultaneously, or in a different order than shown in FIG. 4, as will be understood by a person of ordinary skill in the art. Method 400 shall be described with regard to elements of FIG. 1 and can be performed by the computing device 103 of FIG. 1 and/or computer system 500 of FIG. 5. However, method 400 is not limited to the specific aspects depicted in those figures and other systems can be used to perform the method as will be understood by those skilled in the art.

In 410, the computing device 103 may receive a plurality of transaction requests. The computing device 103 may receive the plurality transaction requests via at least one of a user interface or a merchant webpage. Each transaction request may include respective user information. The respective user information may include data elements associated with the transaction request. For example, for each transaction request of the plurality of transaction requests, the data elements may include at least one of: an email address, a phone number, credit history information, an indication of a value of an asset, or transaction history information.

In 420, the computing device 103 may, for each transaction request of the plurality of transaction requests, determine respective microservices. The computing device 103 may determine the respective microservices based on the data elements associated with the transaction requests. Each microservice of the respective microservices may be tasked to verify a respective data element of the data elements. For each transaction request of the plurality of transaction requests, the computing device 103 may determine the respective microservices by determining a type for each of the data elements, and determining that each microservice of the respective microservices is associated with at least one type of the types of the data elements.

In 430, the computing device 103 may, for each transaction request of the plurality of transaction requests, send to a microservice component of each microservice of the respective microservices, a request to verify the respective data element. For example, each microservice may be configured to communicate with an internal and/or third-party service to verify data elements included with a transaction request. According to some aspects, a microservice may communicate with a third-party system, such as a Public Switched Telephone Network (PSTN), a phone verification API/tool, a reverse phone lookup system, and/or the like to verify phone numbers received with transaction requests to ensure that the phone numbers are valid phone numbers and/or are associated with a particular user device and/or user. A microservice may communicate with a third-party system, such as a real-time verification API, a bulk email list verification system, an email ping device, a public records system, and/or the like to verify email addresses received with transaction requests to ensure that the email addresses are valid and/or are associated with a particular user device and/or user. A microservice may communicate with a third-party system, such as an address verification service (AVS), public records, and/or the like to verify mailing addresses received with transaction requests to ensure that the mailing addresses are valid and/or are associated with a particular user device and/or user. A microservice may communicate with a third-party system 106D, such as credit bureaus, associated merchants, blockchain and/or digital ledger systems storing validated user information, public/private records systems, and/or the like to verify information such as purchase histories, credit scores, and/or trade-in values for assets (e.g., vehicles, collaterals, etc.) received with transaction requests to ensure that a particular user device and/or user is qualified to complete a transaction and/or the like. A microservice may communicate with any device, system, application, and/or the like to verify and/or validate data elements of user information received with transaction requests.

In 440, the computing device 103 may, for each transaction request of the plurality of transaction requests, determine a rank for the transaction request. For example, the computing device 103 may determine a rank for the transaction request based on a number of responses from the microservice components for each of the respective microservices indicating that the respective data elements are verified.

In 450, the computing device 103 may determine the highest-ranked transaction request. For example, the computing device 103 may determine the highest ranked transaction request based on the rank for each transaction request of the plurality of transaction requests. According to some aspects, the method 400 may include the computing device 103 sending, to a user device and/or merchant device, at least one of an indication of the highest-ranked transaction request or the respective user information for the highest-ranked transaction request.

According to some aspects, the method 400 may include the computing device 103 determining a portion of the plurality of transaction requests. The computing device 103 may determine the portion of the plurality of transaction requests based on the rank for each transaction request of the plurality of transaction requests. The rank for each transaction request of the portion of transaction requests may satisfy a ranking threshold. The computing device 103 may send, to a user device and/or merchant device, at least one of an indication of the portion of transaction requests that satisfy the ranking threshold or the respective user information for the portion of transaction requests that satisfy the ranking threshold.

According to some aspects, the method 400 may include the computing device 103 determining another portion of the plurality of transaction requests. The computing device 103 may determine another portion of the plurality of transaction requests based on the rank for each transaction request of the plurality of transaction requests. The rank for each transaction request of the another portion of transaction requests may be less than the ranking threshold. The computing device 103 may send a request for additional data elements to a respective user and/or user device associated with each transaction request of the portion of transaction requests.

Various aspects of this disclosure can be implemented, for example, using one or more computer systems, such as the computer system 500 shown in FIG. 5. Computer system 500 can be used, for example, to implement any method (e.g., the methods 300 & 400, etc.) described herein. Computer system 500 can be any computer capable of performing the functions described herein.

Computer system 500 can be any well-known computer capable of performing the functions described herein.

Computer system 500 includes one or more processors (also called central processing units, or CPUs), such as a processor 504. Processor 504 is connected to a communication infrastructure 506 (a bus, etc.).

One or more processors 504 can each be a graphics processing unit (GPU). In an embodiment, a GPU is a processor that is a specialized electronic circuit designed to process mathematically intensive applications. The GPU can have a parallel structure that is efficient for parallel processing of large blocks of data, such as mathematically intensive data common to computer graphics applications, images, videos, etc.

Computer system 500 also includes user input/output device(s) 503, such as monitors, keyboards, pointing devices, etc., that communicate with communication infrastructure 506 through user input/output interface(s) 502.

Computer system 500 also includes a main or primary memory 508, such as random access memory (RAM). Main memory 508 can include one or more levels of cache. Main memory 508 has stored therein control logic (e.g., computer software) and/or data.

Computer system 500 can also include one or more secondary storage devices or memory 510. Secondary memory 510 can include, for example, a hard disk drive 512 and/or a removable storage device or drive 514. Removable storage drive 514 can be a floppy disk drive, a magnetic tape drive, a compact disk drive, an optical storage device, a tape backup device, and/or any other storage device/drive.

Removable storage drive 514 can interact with a removable storage unit 518. Removable storage unit 518 includes a computer-usable or readable storage device having stored thereon computer software (control logic) and/or data. The removable storage unit 518 can be a floppy disk, magnetic tape, compact disk, DVD, optical storage disk, and/any other computer data storage device. Removable storage drive 514 reads from and/or writes to removable storage unit 518 in a well-known manner.

According to an exemplary embodiment, secondary memory 510 can include other means, instrumentalities, or other approaches for allowing computer programs and/or other instructions and/or data to be accessed by computer system 500. Such means, instrumentalities, or other approaches can include, for example, a removable storage unit 522 and an interface 520. Examples of the removable storage unit 522 and the interface 520 can include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 can further include a communication or network interface 524. Communication interface 524 enables computer system 500 to communicate and interact with any combination of remote devices, remote networks, remote entities, etc. (individually and collectively referenced by reference number 528). For example, communication interface 524 can allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526.

In an embodiment, a tangible apparatus or article of manufacture comprising a tangible computer useable or readable medium having control logic (software) stored thereon is also referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIG. 5. In particular, embodiments may operate with software, hardware, and/or operating system implementations other than those described herein.

It is to be appreciated that the Detailed Description section, and not the Summary and Abstract sections (if any), is intended to be used to interpret the claims. The Summary and Abstract sections (if any) may set forth one or more but not all exemplary embodiments of the disclosure as contemplated by the inventor(s), and thus, are not intended to limit the disclosure or the appended claims in any way.

While the disclosure has been described herein with reference to exemplary embodiments for exemplary fields and applications, it should be understood that the disclosure is not limited thereto. Other embodiments and modifications thereto are possible and are within the scope and spirit of the disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the disclosure should not be limited by any of the above-described exemplary embodiments, but should be defined only in accordance with the following claims and their equivalents.

What is claimed is:

1. A computer-implemented method comprising:
receiving a plurality of transaction requests, wherein each transaction request comprises respective user information, wherein the respective user information comprises data elements associated with the transaction request;
for each transaction request of the plurality of transaction requests:
determining, based on the data elements associated with the transaction request, respective microservices, wherein each microservice of the respective microservices is tasked to verify a respective data element of the data elements,
sending to a microservice component of each microservice of the respective microservices, a request to verify the respective data element, and
determining, based on a number of responses from the microservice components for each of the respective microservices indicating that the respective data elements are verified, a rank for the transaction request; and
determining, based on the rank for each transaction request of the plurality of transaction requests, a highest ranked transaction request.

2. The method of claim 1, wherein the receiving the plurality transaction requests comprises receiving the plurality transaction requests via at least one of a user interface or a merchant webpage.

3. The method of claim 1, wherein, for each transaction request of the plurality of transaction requests, the data elements comprises at least one of an email address, a phone number, credit history information, an indication of a value of an asset, or transaction history information.

4. The method of claim 1, wherein, for each transaction request of the plurality of transaction requests, determining the respective microservices comprises:
determining a type for each of the data elements; and
determining that each microservice of the respective microservices is associated with at least one type of the types of the data elements.

5. The method of claim 1, further comprising sending, to a user device, at least one of an indication of the highest-ranked transaction request or the respective user information for the highest-ranked transaction request.

6. The method of claim 1, further comprising:
determining, based on the rank for each transaction request of the plurality of transaction requests, a portion of the plurality of transaction requests, wherein the rank for each transaction request of the portion of transaction requests satisfy a ranking threshold; and
sending, to a user device, at least one of an indication of the portion of transaction requests that satisfy the ranking threshold or the respective user information for the portion of transaction requests that satisfy the ranking threshold.

7. The method of claim 1, further comprising:
determining, based on the rank for each transaction request of the plurality of transaction requests, a portion of the plurality of transaction requests, wherein the rank for each transaction request of the portion of transaction requests is less than a ranking threshold; and
sending a request for additional data elements to a respective user device associated with each transaction request of the portion of transaction requests.

8. A non-transitory computer-readable device having instructions stored thereon that, when executed by at least one computing device, cause the at least one computing device to perform operations comprising:
receiving a plurality of transaction requests, wherein each transaction request comprises respective user information, wherein the respective user information comprises data elements associated with the transaction request;
for each transaction request of the plurality of transaction requests:
determining, based on the data elements associated with the transaction request, respective microservices, wherein each microservice of the respective microservices is tasked to verify a respective data element of the data elements,
sending to a microservice component of each microservice of the respective microservices, a request to verify the respective data element, and
determining, based on a number of responses from the microservice components for each of the respective microservices indicating that the respective data elements are verified, a rank for the transaction request; and
determining, based on the rank for each transaction request of the plurality of transaction requests, a highest ranked transaction request.

9. The non-transitory computer-readable device of claim 8, wherein the receiving the plurality transaction requests comprises receiving the plurality transaction requests via at least one of a user interface or a merchant webpage.

10. The non-transitory computer-readable device of claim 8, wherein, for each transaction request of the plurality of transaction requests, the data elements comprises at least one of an email address, a phone number, credit history information, an indication of a value of an asset, or transaction history information.

11. The non-transitory computer-readable device of claim 8, wherein, for each transaction request of the plurality of transaction requests, the determining the respective microservices comprises:
determining a type for each of the data elements; and
determining that each microservice of the respective microservices is associated with at least one type of the types of the data elements.

12. The non-transitory computer-readable device of claim 8, further comprising sending, to a user device, at least one of an indication of the highest-ranked transaction request or the respective user information for the highest-ranked transaction request.

13. The non-transitory computer-readable device of claim 8, further comprising:
determining, based on the rank for each transaction request of the plurality of transaction requests, a portion of the plurality of transaction requests, wherein the rank for each transaction request of the portion of transaction requests satisfy a ranking threshold; and
sending, to a user device, at least one of an indication of the portion of transaction requests that satisfy the ranking threshold or the respective user information for the portion of transaction requests that satisfy the ranking threshold.

14. The non-transitory computer-readable device of claim 8, further comprising:
determining, based on the rank for each transaction request of the plurality of transaction requests, a portion of the plurality of transaction requests, wherein the rank for each transaction request of the portion of transaction requests is less than a ranking threshold; and
sending a request for additional data elements to a respective user device associated with each transaction request of the portion of transaction requests.

15. A system comprising:
a memory; and
at least one processor coupled to the memory and configured to:
receive a plurality of transaction requests, wherein each transaction request comprises respective user information, wherein the respective user information comprises data elements associated with the transaction request;
for each transaction request of the plurality of transaction requests:
determine, based on the data elements associated with the transaction request, respective microservices, wherein each microservice of the respective microservices is tasked to verify a respective data element of the data elements,
sending to a microservice component of each microservice of the respective microservices, a request to verify the respective data element, and
determining, based on a number of responses from the microservice components for each of the respective microservices indicating that the respective data elements are verified, a rank for the transaction request; and
determining, based on the rank for each transaction request of the plurality of transaction requests, a highest ranked transaction request.

16. The system of claim 15, wherein the at least one processor configured to receive the plurality transaction requests is further configured to receive the plurality transaction requests via at least one of a user interface or a merchant webpage.

17. The system of claim 15, wherein, for each transaction request of the plurality of transaction requests, the data elements comprises at least one of an email address, a phone number, credit history information, an indication of a value of an asset, or transaction history information.

18. The system of claim 15, wherein, for each transaction request of the plurality of transaction requests, the at least one processor configured to determine the respective microservices is further configured to:
determine a type for each of the data elements; and
determine that each microservice of the respective microservices is associated with at least one type of the types of the data elements.

19. The system of claim 15, wherein the at least one processor is further configured to send, to a user device, at least one of an indication of the highest-ranked transaction request or the respective user information for the highest-ranked transaction request.

20. The system of claim 15, wherein the at least one processor is further configured to:
determine, based on the rank for each transaction request of the plurality of transaction requests, a portion of the plurality of transaction requests, wherein the rank for each transaction request of the portion of transaction requests satisfy a ranking threshold; and
send, to a user device, at least one of an indication of the portion of transaction requests that satisfy the ranking threshold or the respective user information for the portion of transaction requests that satisfy the ranking threshold.
